(19) United States
(12) Patent Application Publication
(10) Pub. No.: US 2007/0254134 A1
(43) Pub. Date: Nov. 1, 2007

(54) Placemat with ribs

(76) Inventor: Allen M. Han, Snoqualmie, WA (US)

Correspondence Address: Allen M. Han, 34726 SE Leitz Street, Snoqualmie, WA, 98065, US

(21) Appl. No.: 11/796,519

(22) Filed: Apr. 28, 2007

Related U.S. Application Data
(60) Provisional application No. 60/795,670, filed on Apr. 28, 2006.

(51) Int. Cl. B32B 7/00

(52) U.S. Cl. 428/120; 428/119

(57) ABSTRACT

According to one embodiment of the present invention, a placemat includes a sheet member of pliable material having a top side and a bottom side and at least one vertical feature on the top side of the sheet member. The vertical feature is configured so that liquid can be contained on the sheet member as the placemat is placed on a surface with the bottom side of the sheet member facing the surface.

### TECHNICAL FIELD

Embodiments of the present invention relate generally to the field of portable placemats that can be placed on or affixed to a flat surface, such as tabletop. More particularly, embodiments of the present invention relate to placemat with ribs.

### BACKGROUND

A placemat is a protective pad typically used on tabletop, countertop, or similar surfaces at households and restaurants. Conventional placemats are usually made of cloth, plastic, or paper. The primary function of placemats is to protect the surface (e.g. tabletop) from food stains, liquid marks, scratches, or other damages such as heat damages. Some placemats also have decorative function, such as placemats made from silk or lace, or designed for holidays.

Another function that placemats serve is to ensure the sanitary nature of an eating surface, particularly for households with a young child. It is generally known that young children often like to eat off of a flat surface, such as a table on which food is served, even when food is served in a bowl or plate or some container. With placemats, the sanitary condition could be more manageable if a clean placemat is used for placing food on, particularly when this occurs in a public area (e.g. restaurants). It is also known that most young children do not have their motor skills fully developed, and therefore, it is not uncommon that a young child spills food or drink or both during meal/snack time.

When liquid is spilled, say, from a cup or a bowl, the area of the surface on which the placemat is placed is protected from the spill. However, often time the liquid is spilled such that it overflows to areas of the surface (e.g. tabletop) that is not covered by the placemat, and maybe even onto the child and/or the floor. Furthermore, the use of a conventional placemat does not prevent accidental spills when container filled with liquid or food is knocked over, since there is usually no mechanism to help secure the container in place on a conventional placemat.

### SUMMARY OF THE INVENTION

According to one embodiment of the present invention, a placemat includes a sheet member of pliable material having a top side and a bottom side and at least one vertical feature on the top side of the sheet member. The at least one vertical feature is configured so that liquid can be contained on the sheet member as the placemat is placed on a surface with the bottom side of the sheet member facing the surface.

According to one embodiment of the present invention, a placemat includes a sheet member of rigid material having a top side and a bottom side and at least one vertical feature on the top side of the sheet member. The at least one vertical feature is configured so that liquid can be contained on the sheet member as the placemat is placed on a surface with the bottom side of the sheet member facing the surface.

### BRIEF DESCRIPTION OF THE DRAWINGS

The present invention is illustrated by way of example, and not by way of limitation, in the figures of the accompanying drawings and in which:

FIG. 1 illustrates an embodiment of a placemat having vertical features.

FIG. 2 illustrates an embodiment of a placemat having vertical features and a pocket.

FIG. 3 illustrates an alternative embodiment of a placemat having vertical features shaped to hold items on the placemat.

FIG. 4 illustrates another embodiment of a placemat having vertical features shaped to depict a design.

### DETAILED DESCRIPTION

Certain details are set forth below to provide a sufficient understanding of embodiments of the present invention. However, it will be clear to one skilled in the art that embodiments of the invention may be practiced without these particular details. Moreover, the particular embodiments of the present invention described herein are provided by way of example and should not be used to limit the scope of the invention to these particular embodiments. In other instances, well-known, well-known components are not described in detail in order to avoid unnecessarily obscuring the present invention. Thus, the specific details set forth are merely for illustration purposes. Particular implementations may vary from these details and still be contemplated to be within the spirit and scope of the present invention.

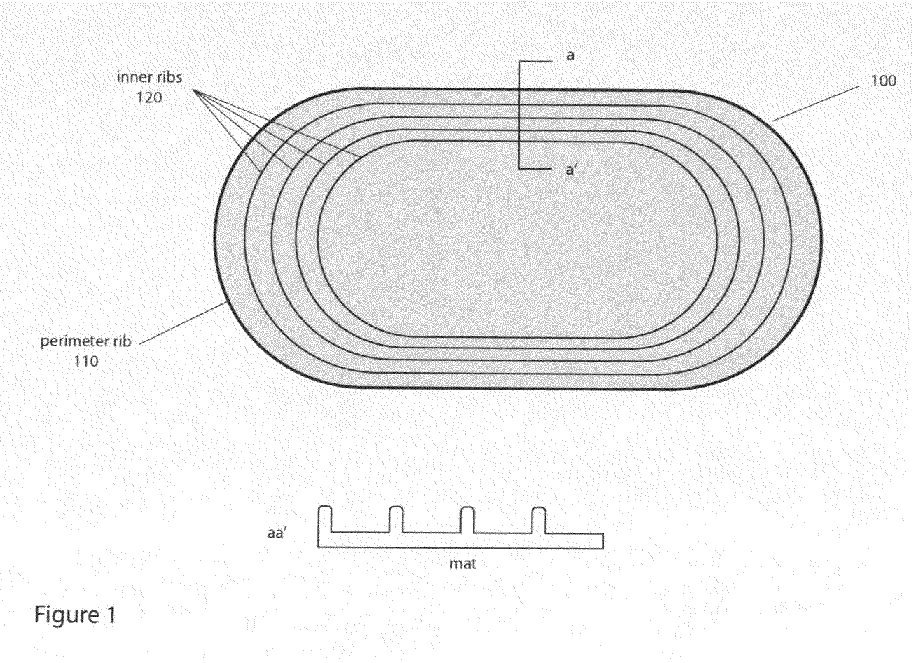

Various embodiments of the present invention are illustrated in FIGS. 1-4. The illustrated placemats have multiple functions depending on the size and the vertical features on the placemat. For example, the placemat could function as a table placemat, a trivet, or a coaster. FIG. 1 illustrates a placemat 100 having vertical features, or ribs, as indicated by the “perimeter rib” and “inner ribs” designations. The cross-section at view of placemat 100 at aa′ further illustrates the vertical ribbing. The perimeter vertical feature, perimeter rib 110, of the placemat 100 provides a wall to contain liquid and solid matter on the placemat 100. For example, at least a portion of a liquid spill onto the placemat would be contained by the perimeter rib 110 and inhibited from flowing off of the placemat 100 onto the surface onto which the placemat 100 is placed, e.g. a tabletop.

In certain embodiments of the present invention, inner vertical features, such as inner ribs 120, of the placemat can help to confine liquid and solid matter within specific locations on the placemat. In another embodiment, inner ribs 120 could also guide the liquid to specific area on the placemat. Although FIG. 1 illustrates a placemat 100 having both perimeter rib 110 and inner ribs 120, it should be clear that other embodiments of the present invention might have perimeter rib but no inner ribs, and vice versa.

The placemat could be made of pliable material that can be rolled up, folded and stowed. Some examples of materials include, but not limited to, rubber and silicone. The placemats could alternatively be made of rigid material for applications in which a placemat is required to maintain its shape under intended application. Some examples of such materials include, but not limited to, ABS plastic, aluminum, etc.

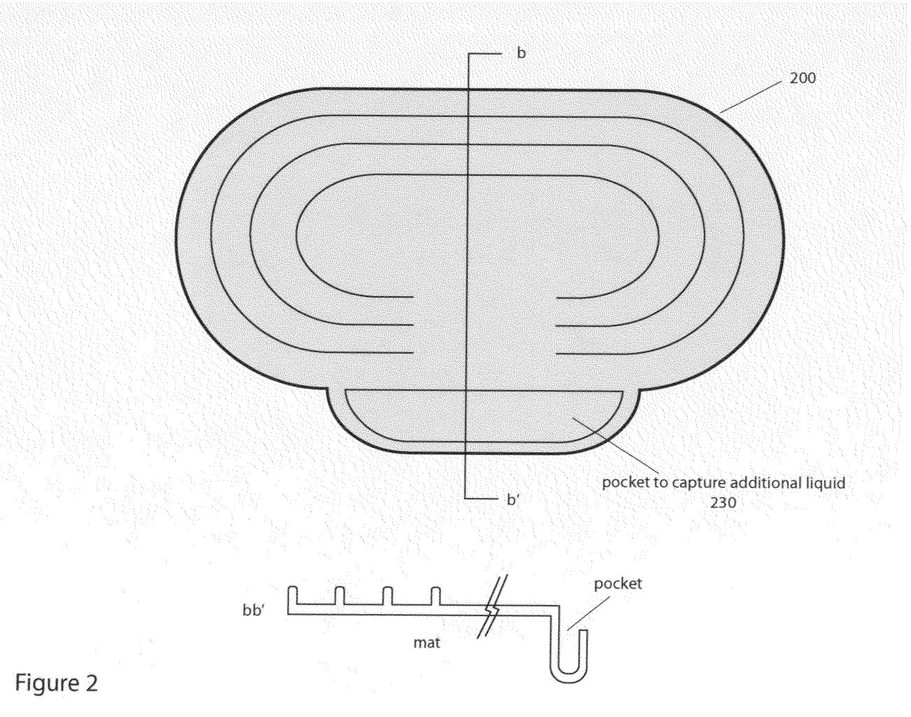

According to another aspect of an embodiment of the placemats, a placemat might have an optional pocket or reservoir on at least one side of a placemat to capture additional liquid or solid matter. The vertical features on the placemat might be designed in such matter to guide the liquid into the pocket/reservoir. As illustrated in FIG. 2, placemat 200 has such a pocket 230, and the cross-sectional view of which at bb′ is also illustrated. In such an embodiment, the pocket may be adapted to hang over the edge of a table or other surface onto which the placemat 200 is placed.

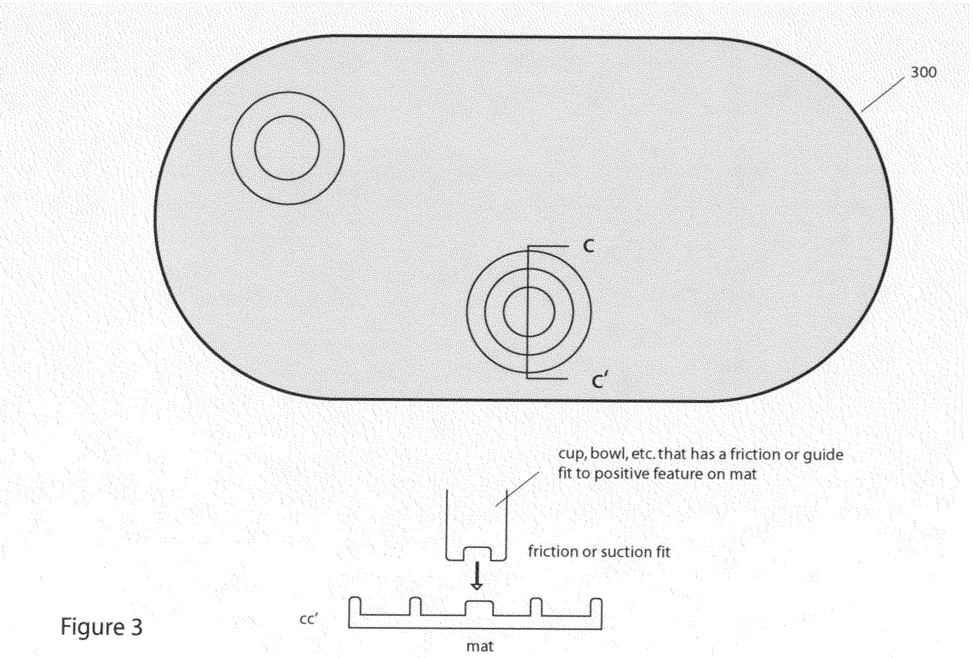

According to an alternative aspect of the vertical features, the vertical features on the placemat might be shaped to function as guides, snaps, locks etc. to secure items placed on top of a placemat. The securing mechanism could be friction fit or suction fit. FIG. 3 illustrates a placemat 300 having various vertical features for such purposes. A cross-sectional view at cc′ illustrates the vertical features on placemat 300 so shaped such that a cup or bowl can be friction or guide fit to be placed on the placemat 300.

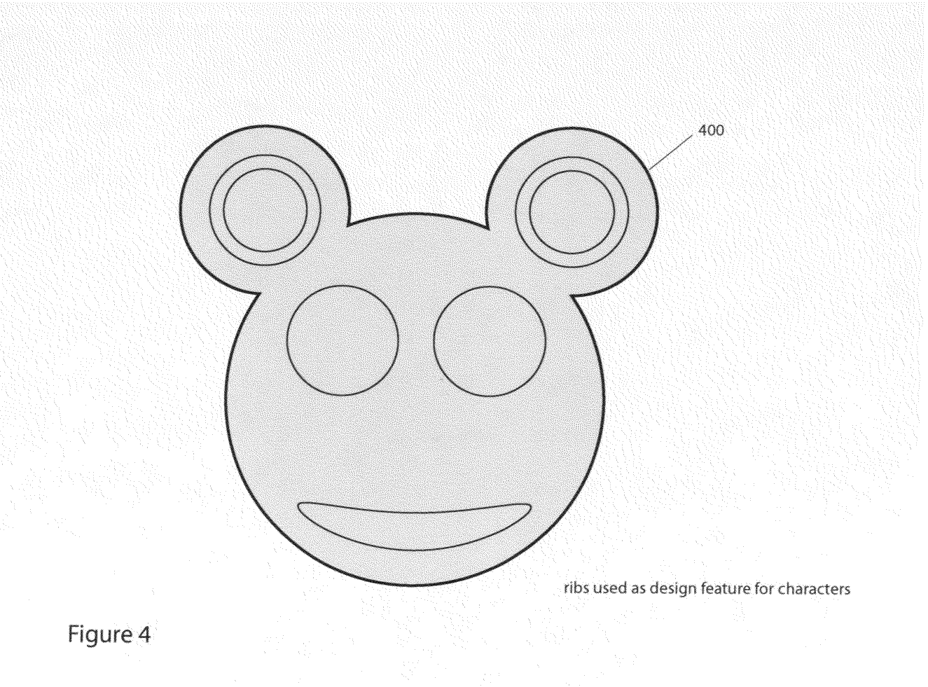

According to another aspect of the vertical features, the vertical features could be designed in such ways to also depict characters, pictures, and/or drawings. FIG. 4 illustrates a placemat 400 with ribs as design feature to depict characters.

Thus, a placemat having a sheet member having a top side and a bottom side and at least one vertical feature on the sheet member configured to contain liquid on the sheet member as the placemat is placed on a surface with the bottom side of the sheet member facing the surface has been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A placemat, comprising:
a sheet member of pliable material having a top side and a bottom side; and
at least one vertical feature on the top side of the sheet member, the at least one vertical feature configured to contain liquid matter on the sheet member as the placemat is placed on a surface with the bottom side of the sheet member facing the surface.

2. The placemat of claim 1 wherein the at least one vertical feature on the top side of the sheet member comprises a perimeter rib on the top side of the sheet member circumscribing the perimeter of the sheet member.

3. The placemat of claim 1 wherein the at least one vertical feature on the top side of the sheet member comprises at least one inner rib on the top side of the sheet member and configured to confine liquid matter within at least one specific location on the sheet member.

4. The placemat of claim 1 wherein the at least one vertical feature on the top side of the sheet member comprises a perimeter rib on the top side of the sheet member circumscribing the perimeter of the sheet member, the at least one vertical feature further comprises at least one inner rib on the top side of the sheet member and configured to confine liquid matter within at least one specific location on the sheet member.

5. The placemat of claim 1 wherein the sheet member comprises a sheet member having at least three sides, and wherein the sheet member further comprising at least one pocket member on at least one of the three sides, the pocket member configured to capture liquid and solid matter.

6. The placemat of claim 5 wherein the pocket member comprises a pocket member adapted to hang over an edge of a surface onto which the placemat is placed.

7. The placemat of claim 5 wherein the at least one vertical feature comprises at least one vertical feature configured to guide at least a portion of a body of liquid that is on the sheet member into the pocket member.

8. The placemat of claim 1 wherein the at least one vertical feature comprises at least one vertical feature configured to allow attachment of at least one item to the sheet member when the at least one item is placed on the sheet member.

9. The placemat of claim 1 wherein the at least one vertical feature comprises at least one vertical feature configured to depict one of a plurality of designs that include characters, pictures, drawings, and geometric shapes.

10. The placemat of claim 1 wherein the pliable material comprises one of rubber and silicone.

11. A placemat, comprising:
a sheet member of rigid material having a top side and a bottom side; and
at least one vertical feature on the top side of the sheet member, the at least one vertical feature configured to contain liquid matter on the sheet member as the placemat is placed on a surface with the bottom side of the sheet member facing the surface.

12. The placemat of claim 1 wherein the at least one vertical feature on the top side of the sheet member comprises a perimeter rib on the top side of the sheet member circumscribing the perimeter of the sheet member.

13. The placemat of claim 1 wherein the at least one vertical feature on the top side of the sheet member comprises at least one inner rib on the top side of the sheet member and configured to confine liquid matter within at least one specific location on the sheet member.

14. The placemat of claim 1 wherein the at least one vertical feature on the top side of the sheet member comprises a perimeter rib on the top side of the sheet member circumscribing the perimeter of the sheet member, the at least one vertical feature further comprises at least one inner rib on the top side of the sheet member and configured to confine liquid matter within at least one specific location on the sheet member.

15. The placemat of claim 1 wherein the sheet member comprises a sheet member having at least three sides, and wherein the sheet member further comprising at least one pocket member on at least one of the three sides, the pocket member configured to capture liquid and solid matter.

16. The placemat of claim 5 wherein the pocket member comprises a pocket member adapted to hang over an edge of a surface onto which the placemat is placed.

17. The placemat of claim 5 wherein the at least one vertical feature comprises at least one vertical feature configured to guide at least a portion of a body of liquid that is on the sheet member into the pocket member.

18. The placemat of claim 1 wherein the at least one vertical feature comprises at least one vertical feature configured to allow attachment of at least one item to the sheet member when the at least one item is placed on the sheet member.

19. The placemat of claim 1 wherein the at least one vertical feature comprises at least one vertical feature configured to depict one of a plurality of designs that include characters, pictures, drawings, and geometric shapes.

20. The placemat of claim 1 wherein the rigid material comprises one of ABS plastic and aluminum.
